(19) United States
(12) Patent Application Publication
(10) Pub. No.: US 2019/0025459 A1
(43) Pub. Date: Jan. 24, 2019

(54) Calibrating a corrosion detection tool

(71) Applicant: Halliburton Energy Services, Inc., Houston, TX (US)

(72) Inventors: Luis Emilio San Martin, Houston, TX (US); Reza Khalaj Amineh, Houston, TX (US)

(73) Assignee: Halliburton Energy Services, Inc., Houston, TX (US)

(21) Appl. No.: 15/745,640

(22) PCT Filed: Dec. 22, 2016
(86) PCT No.: PCT/US2016/068415

§ 371 Date: Jan. 17, 2018

(51) Int. Cl. G01V 13/00; E21B 47/00; G01V 3/28

(52) U.S. Cl. CPC G01V 13/00; G01V 3/28; E21B 47/00

(57) ABSTRACT

Methods and systems for calibrating a corrosion detection tool may comprise: disposing the corrosion detection tool in a calibration area; powering a transmitter and measuring a response on a receiver on the corrosion detection tool; disposing the corrosion detection tool in a test pipe; powering the transmitter and measuring the response on the receiver on the corrosion detection tool while disposed within the test pipe; and determining a multiplicative factor for the receiver. A system may comprise: a corrosion detection tool, wherein the corrosion detection tool comprises: a transmitter; a receiver; and a bucked coil; a test pipe; and an information handling system. A method for operating a corrosion detection tool may comprise: disposing the corrosion detection tool in a tubular string; powering the transmitter; measuring a response on a receiver on the corrosion detection tool while disposed within the tubular string; and calculating properties of the tubular string.

### BACKGROUND

For oil and gas exploration and production, a network of wells installations and other conduits may be established by connecting sections of metal pipe together. For example, a well installation may be completed, in part, by lowering multiple sections of metal pipe (i.e., a casing string) into a borehole, and cementing the casing string in place. In some well installations, multiple casing strings are employed (e.g., a concentric multi-string arrangement) to allow for different operations related to well completion, production, or enhanced oil recovery (EOR) options.

Corrosion of metal pipes is an ongoing issue. Efforts to mitigate corrosion include use of corrosion-resistant alloys, coatings, treatments, corrosion transfer, etc. Also, efforts to improve corrosion monitoring are ongoing. For downhole casing strings, various types of corrosion monitoring tools are available. One type of corrosion detection tool uses electromagnetic (EM) fields to estimate pipe thickness or other corrosion indicators. As an example, a corrosion detection tool may collect EM log data, where the EM log data can be interpreted to correlate a level of flux leakage or EM induction with corrosion. Corrosion detection tools may be very sensitive and/or complex devices. Properly calibrating corrosion detection tools may allow an operator to locate corrosion within a metal pipe. Calibration of a corrosion detection tool may be a complex and time consuming task.

### BRIEF DESCRIPTION OF THE DRAWINGS

These drawings illustrate certain aspects of some examples of the present disclosure, and should not be used to limit or define the disclosure.

FIG. 1 is a schematic illustration of an example of an operating environment for a corrosion detection tool;

FIG. 2 is a schematic illustration of an example of a corrosion detection tool;

FIG. 3 is a schematic illustration of an example of a main coil and a bucked coil;

FIG. 4a-4c illustrates graphs of response change for the receivers due to the metal tube that may be a part of tool chassis and goes inside the antennas when the measurements are performed in air;

FIG. 5a-5e illustrates graphs of calibration measurements of response change for the receivers due to the metal tube that may be a part of tool chassis and goes inside the antennas when the measurements are performed in a test pipe;

FIG. 6 illustrates a flow chart of an example method of calibrating a corrosion detection tool;

FIG. 7(a) illustrates a graph of an example of an ideal voltage reading across receivers on a corrosion detection tool;

FIG. 7(b) illustrates a graph of an example of an actual voltage reading across receivers on a corrosion detection tool;

FIG. 8 illustrates a flow chart of an example method for calibrating a corrosion detection tool to account for temperature changes; and

FIG. 9 illustrates a flow chart of an example inversion method.

### DETAILED DESCRIPTION

This disclosure may generally relate to systems and methods for the calibration of a corrosion detection tool. Electromagnetic (EM) sensing may provide continuous in situ measurements of parameters related to the integrity of pipes in cased boreholes. As a result, EM may be used in cased borehole monitoring applications. Corrosion detection tools may be configured for multiple concentric pipes (e.g., for one or more) with the first pipe diameter varying (e.g., from two to seven inches). Corrosion detection tools may measure eddy currents to determine metal loss and use magnetic cores at the transmitters. The corrosion detection tools may use pulse eddy current (time-domain) and may employ multiple (long, short, and transversal) coils to evaluate multiple types of defects in double pipes. The corrosion detection tools may operate in wireline logging. Additionally, a corrosion detection tool may operate on a slick-line or other conveyance. The corrosion detection tool may include an independent power supply and may store the acquired data on memory. A magnetic core may be used in defect detection in multiple concentric pipes.

In corrosion detection tools, the interpretation of the data may be based on differences between responses at two different points along the log, a point representing a nominal section and a point where thickness may be estimated. The response differences may be processed to determine the change in wall thickness caused by corrosion within a tubular. During operation, additive errors may be irrelevant and multiplicative errors may cause interpretation problems. Multiplicative errors may be corrected to preserve the correct interpretation of change in thickness within a tubular.

In examples disclosed below, receivers may be placed on the corrosion detection tool at short distances from a transmitter. Direct coupling may cause a corrosion detection tool's sensitivity to pipe defects to be very low. One method to increase the sensitivity may involve bucking a coil (e.g., a bucked coil) to cancel the direct signal. A bucked coil may have increased sensitivity to inner pipe defects. The optimal sensitivity values may require approximate cancellation of the direct signal within pipe. Additionally, a calibration method may be utilized to maintain accuracy of the interpretation method and to ensure that receivers disposed close to the transmitter may have optimal sensitivity to defects in the inner pipes.

Corrosion detection tools may comprise a transmitter-receiver system, wherein the transmitter-receiver system may comprise a transmitter, such as, for example, a solenoid transmitter and a magnetic core. The use of solenoid transmitters with magnetic cores may provide an increased signal for the same amount of current injected in the solenoid transmitter. By using a magnetic core, the inductance of the solenoid transmitter may increase and the same amount of power may be delivered with a fraction of the current, which is convenient to reduce cross-talk within the corrosion detection tool. The ratio of the currents required with and without the core for the same amount of power, provided the magnetic core does not saturate, may be approximately proportional to the core relative permeability.

In corrosion detection tool applications, it may be important that the response of the transmitter-receiver system be stable over the range of possible applications. Two important areas of concern may be the stability with a variable innermost pipe radius and stability with temperature.

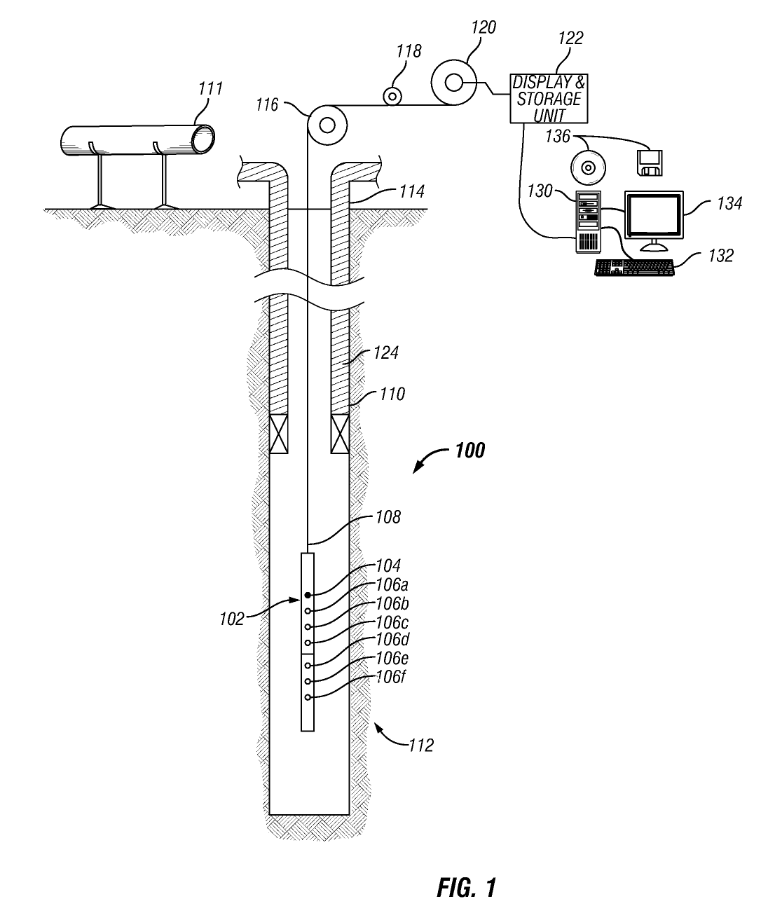

FIG. 1 illustrates an operating environment for a corrosion detection tool system 100 as disclosed herein. Corrosion detection tool 102 may comprise transmitter 104 and receivers 106a-106f. Corrosion detection tool 102 may be operatively coupled to conveyance 108 which may provide electrical connectivity, as well as mechanical suspension, for corrosion detection tool 102. Conveyance 108 and corrosion detection tool 102 may extend within casing string 110 to a desired depth within wellbore 112. A test pipe 111, which may be representative of casing string 110 is disposed on the surface for calibration of corrosion detection tool 102. Conveyance 108 may exit wellhead 114, may pass around pulley 116, may engage odometer 118, and may be reeled onto winch 120, which may be employed to raise and lower the corrosion detection tool 102 in the wellbore 112. Conveyance 108 may include any suitable conveyance means for corrosion detection tool 102, including, but not limited to, a wireline, slickline, coiled tubing, pipe, or the like, which may provide mechanical suspension as well as electrical conductivity for corrosion detection tool 102. Where signal communication to the surface is provided, the electrical signals from conveyance 108 may be conducted from winch 120 and connected to information handling system 122 where the signals may be processed, and the information contained therein may be displayed for an operator to observe and stored for future processing and reference. It should be noted that information handling system 122 may be disposed on the surface and/or corrosion detection tool 102. Processing of information may be performed on the surface and/or downhole. Downhole processing may occur when information handling system 122 is disposed on corrosion detection tool 102 and corrosion detection tool 102 may be disposed within wellbore 112. Processing downhole may be transmitted to the surface from corrosion detection tool 102. Transmitted information may be recorded, displayed, further analyzed, and/or the like. Information handling system 122, described below, may also contain an apparatus for supplying control signals and power to the downhole tool assembly, wherein the downhole tool assembly comprises corrosion detection tool 102.

A typical casing string 110 may extend from wellhead 114 at or above ground level to a selected depth within wellbore 112. Casing string 110 may comprise a plurality of joints or segments of casing, each segment being connected to the adjacent segments by a threaded collar.

FIG. 1 also illustrates a typical tubular string 124, which may be positioned inside of casing string 110 extending part of the distance down wellbore. In examples, a packer 126 may seal the lower end of the tubular-casing annulus and may secure the lower end of the tubular string 124 to casing 128. Corrosion detection tool 102 may be dimensioned so that it may be lowered into wellbore 112 through tubular string 124, thus avoiding the difficulty and expense associated with pulling tubular string 124 out of wellbore 112.

In logging systems, such as, for example, logging systems utilizing corrosion detection tool 102, a digital telemetry system may be employed, wherein an electrical circuit may be used to both supply power to corrosion detection tool 102 and to transfer data between information handling system 122 and corrosion detection tool 102. A DC voltage may be provided to corrosion detection tool 102 by a power supply located above ground level, and data may be coupled to the DC power conductor by a baseband current pulse system. Alternatively, corrosion detection tool 102 may be powered by batteries located within the downhole tool assembly, and/or the data provided by corrosion detection tool 102 may be stored within the downhole tool assembly, rather than transmitted to the surface during logging (corrosion detection).

Systems and methods of the present disclosure may be implemented, at least in part, with information handling system 122. Information handling system 122 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, information handling system 122 may be a personal computer 130, a network storage device, or any other suitable device and may vary in size, shape, performance, functionality, and price. Information handling system 122 may include random access memory (RAM), one or more processing resources such as a central processing unit (CPU) or hardware or software control logic, ROM, and/or other types of nonvolatile memory. Additional components of information handling system 122 may include one or more disk drives, one or more network ports for communication with external devices as well as various input and output (I/O) devices, such as a keyboard 132, a mouse, and a video display 134. Information handling system 122 may also include one or more buses operable to transmit communications between the various hardware components.

Alternatively, systems and methods of the present disclosure may be implemented, at least in part, with non-transitory computer-readable media 136. Non-transitory computer-readable media may include any instrumentality or aggregation of instrumentalities that may retain data and/or instructions for a period of time. Non-transitory computer-readable media 136 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

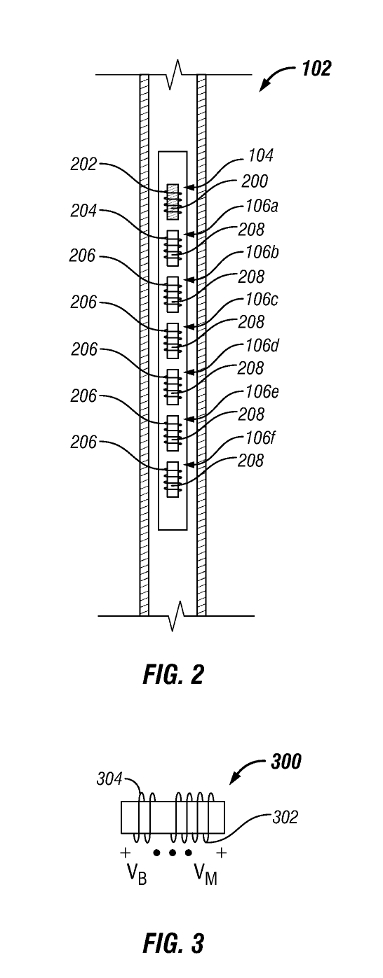

FIG. 2 illustrates corrosion detection tool 102 disposed within wellbore 112. In examples, corrosion detection tool 102 may comprise a plurality of receivers 106a-106f disposed at different distances from transmitter 104. Receivers 106a-106f may be referred to collectively as receivers 106a-106f and individually as first receiver 106a, second receiver 106b, third receiver 106c, fourth receiver 106d, fifth receiver 106e, and sixth receiver 106f. Transmitter 104 may comprise a magnetic core 200. Different configurations of transmitter 104 in relation to receivers 106a-106f may benefit from the calibration procedure described below. In examples, magnetic core 200 may provide an increased signal level with smaller current, which may improve signal to noise ratios and reduce “cross talk.” In examples, magnetic core 200 may be encompassed by a sense coil 202, which may be interspersed to measure the excitation field at transmitter 104. For a fixed amount of current within transmitter 104, the use of magnetic core 200 may increase a signal level. Transmitter 104 may include windings 204 (windings of wire), wherein the windings 204 may be interspersed with the sense coil 202 that may be used to measure a field generated by transmitter 104. As illustrated, receivers 106a-106f may comprise receiver magnetic core 208 and/or receiver windings 206. In examples, receiver magnetic core 208 and receiver windings 206 may increase the sensitivity of measurement of receivers 106.

Corrosion detection tool 102 may be used in pipes having any suitable outside diameter, including, but not limited to, about 2 inches (5.1 cm) to about 18 inches (46 cm). The outside diameter of transmitter 104 may range from about 0.5 inch to about 2 inches. The number of turns on transmitter 104 may be about 200 to about 5000. The length of transmitter 104 may be about 4 inches to about 20 inches. The outside diameter of receiver 106 may range from about 0.5 inch to about 2 inches. The number of turns on receiver 106 may be about 200 to about 5000. The length of receiver 106 may be about 4 inches to about 20 inches. Transmitter 104 and receiver 106 may be separated by a length of about 4 inches to about 80 inches.

In examples, the first receiver 106a and second receiver 106b closest to transmitter 104 may comprise a near-field region. The third receiver 106c and fourth receiver 106d may comprise a transition region, and the fifth receiver 106e and sixth receiver 106f may comprise a far-field region. Disposed in the near-field region may be a bucked coil 300, which is illustrated on FIG. 3. Bucked coil 300 may comprise two sub-windings wound in opposite directions, e.g., a first winding 302 wound in a first direction and second winding 304 wound in a second direction. Bucked coil 300 may replace first receiver 106a and/or second receiver 106b. First winding 302 and second winding 304 may operate to nullify a magnitude of direct-field produced by transmitter 104, referring to FIG. 2, in different configuration of corrosion detection tool 102. In examples, the number of turns of first winding 302 and second winding 304 and the distance between the bucked coil in 300 and the transmitter 104 (referring to FIG. 2) may be adjusted to minimize the magnitude of the differential response of first winding 302 and second winding 304. During operation, the transmission of electromagnetic fields by transmitter 104 and the recordation of signals by receivers 106a-106f may be controlled by information handling system 122 (referring to FIG. 1). However, before operation downhole within wellbore 112, referring to FIG. 1, corrosion detection tool 102 may be calibrated to ensure that receivers 106a-106f and transmitters 104 may be operating optimally.

A method for calibration may comprise taking measurements in “air” and/or a calibration area which may be defined as an area away from metal. An area away from metal may be defined as a large area that does not have any metal in the vicinity of the corrosion detection tool 102 such that the measurements would represent the measurements in the air without the presence of metal. Calibration may be performed by an information handling system 122. Calibration may bring receivers 106a-106f measurements within acceptable tolerance ranges, which may help identify possible malfunctioning in corrosion detection tool 102. During calibration, measurements may take into account the signature of all metal parts that may introduce error in the measurement. For example, the structural housing that may be a part of corrosion detection tool 102 and/or receivers 106a-106f which may affect the measurement with an error that may be frequency dependent. This effect may be characterized at calibration time to account for it in the measurements. Typically, this effect may be equivalent to a constant multiplicative factor, a reduction of the area of receivers 106a-106f. To correct this effect, the responses of receivers 106a-106f in corrosion detection tool 102 may take measurements in the “air” to avoid the effect of tubular. Measurements may be taken within a facility and/or at a job site calibration area, an area from metallic objects that may generate significant signals, a possible area may be about 20 feet above the ground lifted by a non-metallic structure. The changes in the responses of receivers 106a-106f measured may yield multiplicative factors that may be used to compensate for the effect of the structural housing, which may allow for further correction within a test pipe 111.

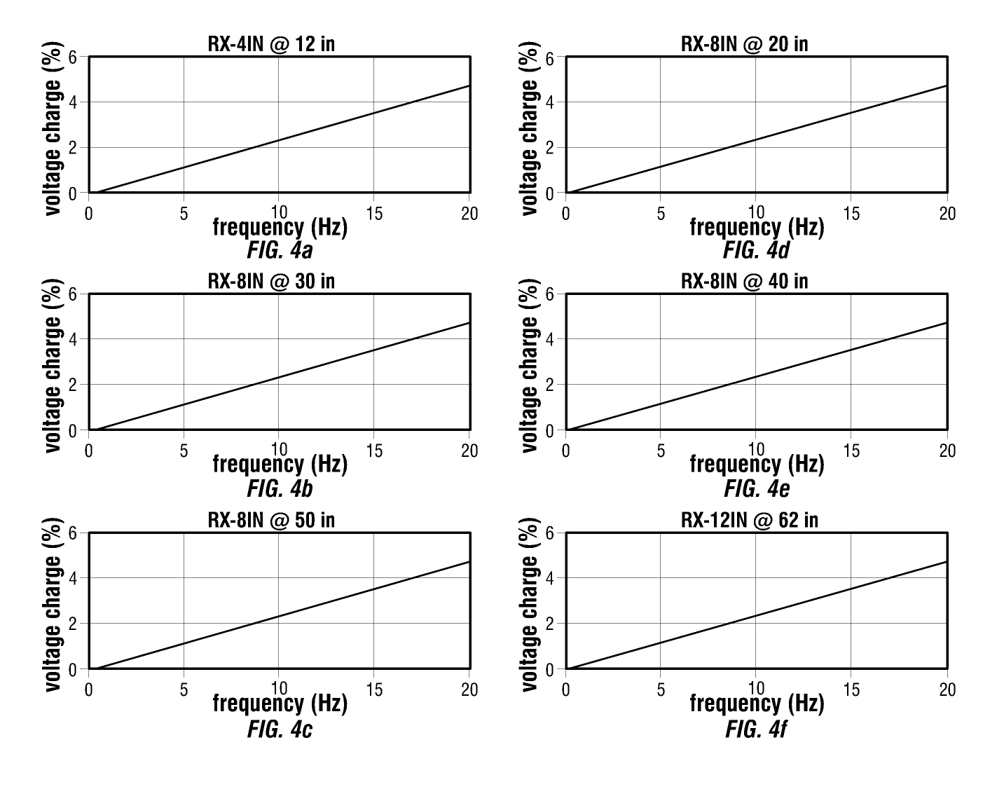

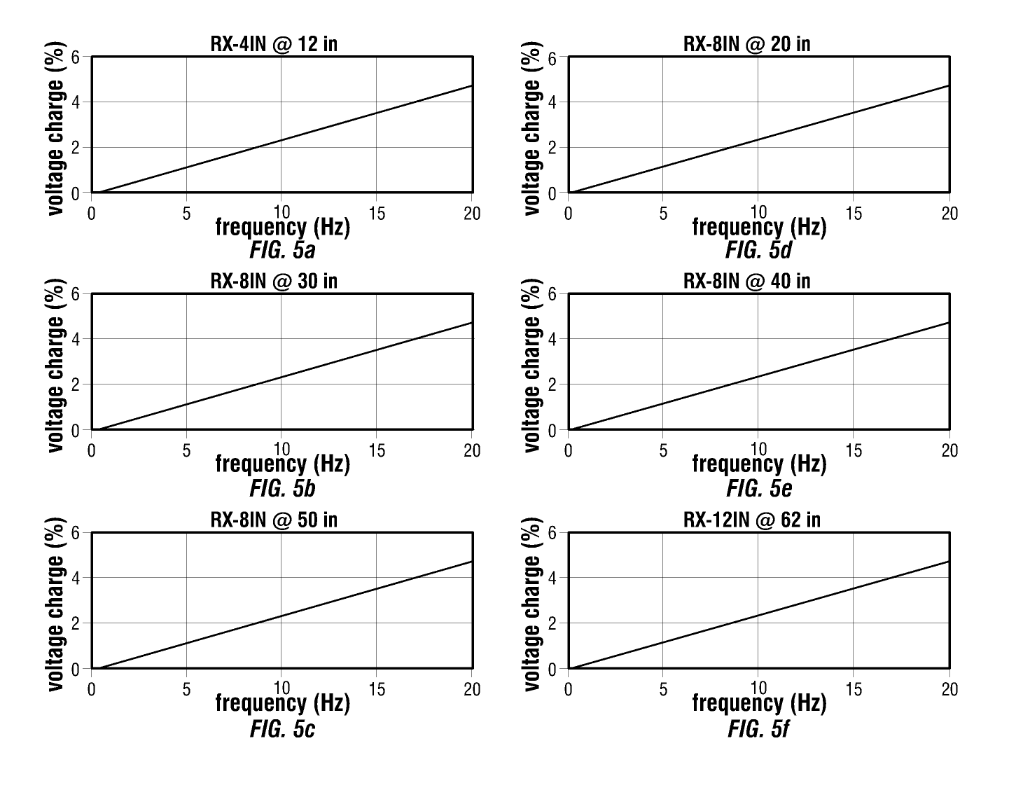

Transmitter 104 may comprise magnetic core 200 with known physical parameters. Receivers 106a-106f may be simulated once with the presence of the structure housing of corrosion detection tool 102 and a second time without the presence of the structure housing. To illustrate use of the corrosion detection tool 102, a simulation was performed assuming the outside dimension of the housing was 0.8 inches and includes four concentric pipes with outside diameters of 2⅞ in, 5 in, 9⅝ in, and 13⅜ in and nominal thicknesses of 0.21 in, 0.62 in, 0.54 in, and 0.51 in, respectively. We simulated the receiver responses at a number of frequencies in a range between 0.5 Hz, and 20 Hz. FIGS. 4a-4c and 5a-5e show the percentage changes of the receiver responses due to the structural housing when corrosion detection tool 102 is in the air (Referring to FIGS. 4a-4c) and when corrosion detection tool 102 is inside the pipes may be similar, which may confirm the above described calibration process.

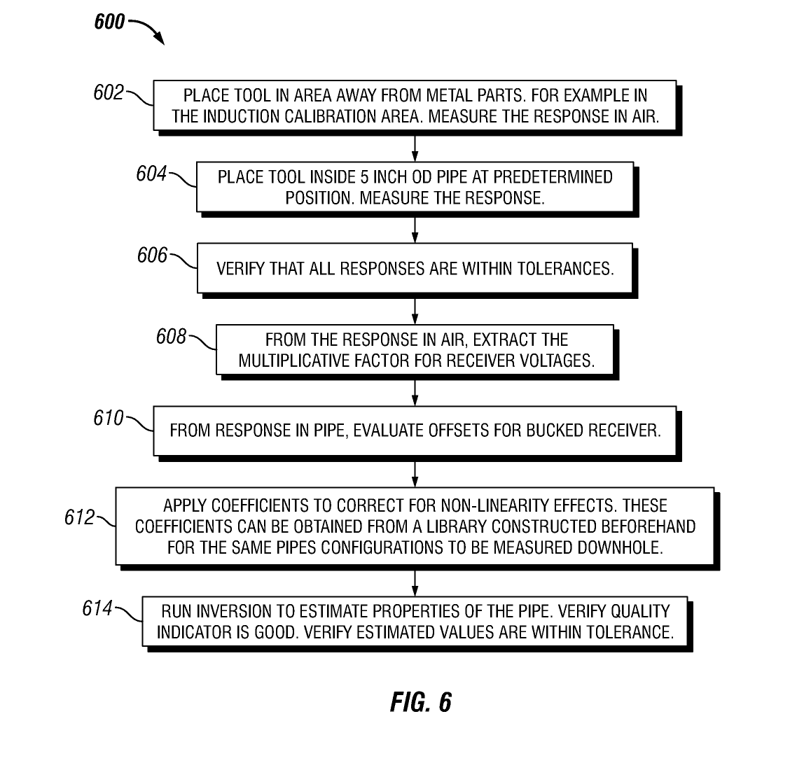

FIG. 6 illustrates a flow chart 600 which illustrates calibration steps for calibrating corrosion detection tool 102, which may be performed by an information handling system 122. In block 602, corrosion detection tool 102 may be placed into area away from metal parts. For example, the corrosion detection tool 102 may be placed in an induction calibration area at a facility to take measurements of corrosion detection tool 102 operating in “air.” In block 604, corrosion detection tool 102 may be placed within a test pipe 111 (Referring to FIG. 1) at a predetermined position within the test pipe 111 and measurements of corrosion detection tool 102 may be taken. Block 606 provides a step that verifies that all responses are within tolerances. In block 608, the measurements taken in “air” may be used to extract multiplicative factors for receiver voltages. A ratio between the responses may be obtained from measurements with metallic parts of detection tool 102 and without the metallic parts of detection tool 102. FIGS. 4a-4c and 5a-5e illustrate that the ratios may be the same in the air and in the pipe. Thus, the multiplicative factors that may take into account the metallic parts of corrosion detection tool 102 may be obtained from measurements in the air and may be used to correct for the simulation responses in the test pipe 111 to correct the response for those metallic parts. In block 610, the measurements in the test pipe 111 may be evaluated for offsets for bucked coil 300 (referring to FIG. 3). Another set of parameters that may be found from tests with the test pipe 111 may be correction parameters to improve the accuracy of a forward model and/or a library of responses. The correction parameters may be found to take into account effects such as non-linearity of magnetic core 200 and downhole pipe which may normally not be taken into account in forward models. In block 612, the coefficients found may be applied to measurements from corrosion detection tool 102 to correct for non-linearity effects. In block 614, an inversion scheme to estimate properties of the test pipe 111 may be run on information handling system 122. The inversion may take into account physical parameters of the test pipe 111, geometry of test pipe 111, filtering to reduce noise, averaging multiple sensor data to reduce noise, taking the difference to the ratio of multiple voltages to normalize the data, removing unwanted effects such as a common voltage drift due to temperature, and/or temperature correction. The inversion is checked to make sure the estimated values are within tolerance to determine if corrosion detection tool 102 is sufficiently calibrated for operation. The inversion step may be optional as the verification of tool performance may be performed by comparing the raw signals measure by the tool before processing.

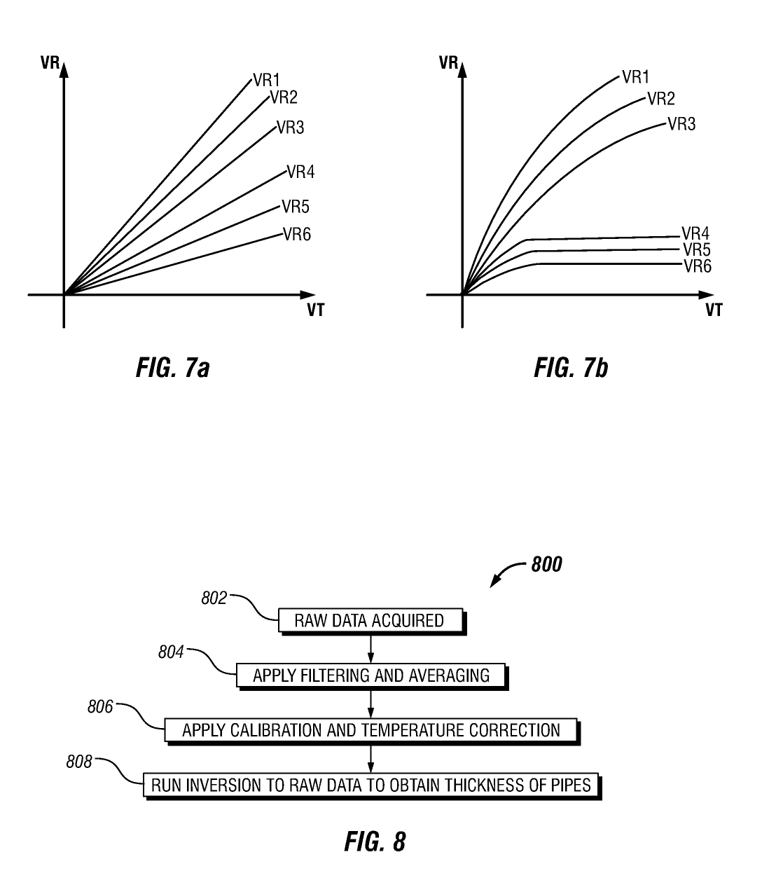

FIG. 7(a) illustrates a graph of ideal voltage readings across receivers 106a-106f and FIG. 7(b) illustrate a graph of actual voltage readings across receivers 106a-106f. In examples, when taking measurements in a corrosion detection tool system 100 (referring to FIG. 1) with linear magnetic core 200 and pipe materials, there may be linear variation of the voltages of receivers VR1 to VR6 with respect to the voltage of transmitter 104, as illustrated in FIG. 7(a). However, due to the non-linearities of the magnetic cores 200 (in particular magnetic core 200 for transmitter 104) and the pipes, the receiver voltages VR1 to VR6 may change non-linearly with respect to the transmitter voltage VT, as illustrated in FIG. 7(b). If the non-linear effect may only be due to magnetic core 200 of the transmitter 104, the flux produced by transmitter 104 has a non-linear relation with respect to the applied voltage VT and, therefore, all receivers 106a to 106f show similar non-linear behavior with respect to VT (non-linearity starts at the same value of VT for all the receivers when increasing VT). However, if non-linearities of pipes are also taken into account, receivers 106a to 106f may show different non-linear behavior with respect to the VT. Receivers 106a to 106f closer to transmitter 104 may suffer less non-linear effects while those further away show more non-linear behavior (non-linear variation starts for smaller values of VT). The effect may be a clue to, that in the vicinity of transmitter 104, larger flux passes the pipes and this leads to pushing the pipes closer to magnetic saturation levels, lowering the effective permeability of the pipes, increasing the magnetic reluctance of the pipes, and ultimately blocking a portion of the flux to reach to points further away. Thus, receivers 106a to 106f that may be further away receive lower flux and produce lower voltage levels than what may be expected from a linear pipe model. The effect of these non-linear effects may be evaluated on the surface by information handling system 122 for various numbers of pipes with known dimensions and properties for a particular corrosion detection tool 102. Correction parameters may be obtained such that the difference between the forward model or library of responses and the measured responses for receivers 106a to 106f in corrosion detection tool 102 may be minimized. These correction parameters may then be applied on the forward model or library of response when using the measured responses of corrosion detection tool 102 downhole and employed them in an inversion algorithm. These coefficients may represent a local linearization of the nonlinear problem of described in FIG. 7(b).

As illustrated in FIG. 8, a temperature calibration method 800 may be applied to further correct measurements of corrosion detection tool 102 (referring to FIG. 1), which may be performed by an information handling system 122. Correction with respect to temperature may be needed to account for the changes in the material properties due to temperature and the possible changes in the electronics and/or parts of corrosion detection tool 102 due to the temperature change. In block 802, raw data from measurements may be acquired. In block 804, filtering and averaging may be applied to the data. In block 806, calibration and temperature correction may be applied to measurements from corrosion detection tool 102. The effect of temperature may be observed as a smooth change in the background response (for the nominal sections of the pipes). By detecting such variation and applying proper signal processing tools (such as filters) this effect may be reduced). In block 808, an inversion scheme may be applied to raw data to obtain a thickness of tubular string 124.

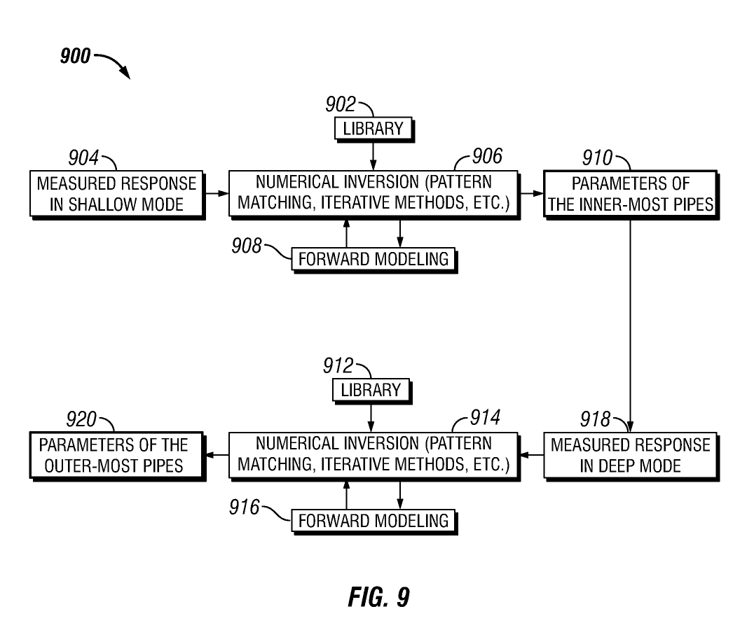

FIG. 9 is an illustration of a flow diagram for an inversion scheme 900, which may be performed by an information handling system 122 (referring to FIG. 1). Block 902 may include a library including pre-computed responses. Block 904 may include a measured response in a shallow mode. Block 906 may process block 902 and block 904 via inversion (e.g., pattern matching, iterative methods) and forward modeling, as shown in block 908. After the processing in block 906, parameters of the inner-most pipes may be provided, as shown in block 910. Block 910 may be used with a measured response in deep mode, as shown in block 918. Block 912 may include a library including pre-computed responses. Block 912, block 916, which may include forward modeling, and block 918 may be processed by block 914 via inversion (e.g., pattern matching, iterative methods) to provide parameters of the outer-most pipes, as shown in block 920. An inversion scheme may include operations that may be required to convert measured responses to pipe parameters. A general picture of the inversion scheme may be as follows: the measured response may be compared to signals in a library or signals from a forward modeling code and an iterative numerical optimization problem may be solved based on the difference between the two. A numerical model of the casing may be constructed for forward modeling and construction of the library.

Forward modeling may include a technique for determining what a given one of receivers 106a to 106f would measure in a given formation and environment by applying a set of theoretical equations for the sensor response. Forward modeling may be used to determine a general response of many electromagnetic logging measurements. Forward modeling may also be used for interpretation, particularly in horizontal wells and complex environments. A set of theoretical equations (the forward models) may be 1D, 2D or 3D.

Effects due to the presence of sensor housing, pad structure, and mutual coupling between transmitter 104 and receivers 106a to 106f may be corrected by using prior information on these effects on measurements, or by solving for some or all of them during the inversion process. Since all of these effects may be mainly additive, they may be removed by using proper calibration schemes. Multiplicative (scaling) portion of the effects may be removed in the process of calibration to an existing log or by using a calibration experiment and comparison between experiment and numerical modeling. All additive, multiplicative and any other non-linear effect may be solved for by including them in the inversion process as a parameter. By detecting and estimating the size of smaller defects, more valid predictions may be performed on the useful life-time of the tubular/casings or a decision may be made for replacing flawed sections.

This method and system may include any of the various features of the compositions, methods, and system disclosed herein, including one or more of the following statements.

Statement 1: A method for calibrating a corrosion detection tool comprising: disposing the corrosion detection tool in a calibration area; powering a transmitter and measuring a response on a receiver on the corrosion detection tool; disposing the corrosion detection tool in a test pipe; powering the transmitter and measuring the response on the receiver on the corrosion detection tool while disposed within the test pipe; and determining a multiplicative factor for the receiver.

Statement 2: The method of statement 1, further comprising determining an offset for a bucked coil on the corrosion detection tool.

Statement 3: The method of statement 2 or statement 1, further comprising altering a structure of the bucked coil or a number of turns of the bucked coil to place the bucked coil within tolerances.

Statement 4: The method of any preceding statement, further comprising applying coefficients to measurements for the receiver to correct for non-linear measured responses, wherein the coefficients are obtained from a library of responses.

Statement 5: The method of any preceding statement, wherein the library of responses is constructed from data on different configurations of a tubular string.

Statement 6: The method of any preceding statement, further comprising performing an inversion to estimate properties of the test pipe.

Statement 7: The method of any preceding statement, wherein the inversion is verified within an allowable tolerance.

Statement 8: The method of any preceding statement, further comprising performing a temperature correction which comprises: acquiring raw data, applying filtering and averaging to the raw data, applying calibration and temperature correction to the raw data, and performing an inversion on the raw data to obtain a thickness of a tubular string.

Statement 9: A system comprising: a corrosion detection tool, wherein the corrosion detection tool comprises: a transmitter; a receiver; and a bucked coil; a test pipe; and an information handling system, wherein the information handling system is operable to perform determine a multiplicative factor for the receiver based on a first response measured for the receiver in a calibration area and a second response measured for the receiver in a test pipe.

Statement 10: The system of statement 9, wherein the bucked coil may comprise one or more sub-windings wound in opposite directions, wherein a first winding is wound in a first direction and a second winding is wound in a second direction.

Statement 11: The system of statement 9 or 10, wherein the information handling system is operable to apply a coefficient to correct for non-linear measured responses, wherein the coefficient is obtained from a library of coefficients.

Statement 12: The system of any preceding statement, wherein the information handling system is operable to perform an inversion to estimate properties of the test pipe.

Statement 13: The system of any preceding statement, wherein the information handling system is operable to power the transmitter and measure a response on the receiver on the corrosion detection tool.

Statement 14: The system of any preceding statement, wherein the information handling system is operable to power the transmitter and measure a response on the receiver on the corrosion detection tool where the corrosion detection tool is disposed in the test pipe.

Statement 15: The system of any preceding statement, further comprising a plurality of receivers on the corrosion detection tool.

Statement 16: A method for operating a corrosion detection tool comprising: disposing the corrosion detection tool in a tubular string; powering the transmitter; measuring a response on a receiver on the corrosion detection tool while disposed within the tubular string; storing the response as a raw data from the receiver on an information handling system; and calculating properties of the tubular string from the raw data.

Statement 17: The method of statement 16, further comprising a step to determine parameters of an inner-most pipe which comprises measuring a response in a shallow mode on the corrosion detection tool, performing a numerical inversion with data from a library and a forward model, and producing the parameters of the inner-most pipe.

Statement 18: The method of statement 16 or statement 17, further comprising a step to determine parameters of an outer-most pipe which comprises measuring a response in a deep mode on the corrosion detection tool, performing a numerical inversion with data from a library and a forward model from the parameters of an outer-most pipes, and producing the parameters of the outer-most pipe.

Statement 19: The method of any preceding statement, wherein the information handling system is operable to perform a temperature correction which comprises, applying filtering and averaging to the raw data, applying calibration and temperature correction to the raw data, and performing an inversion on the raw data to obtain a thickness of the tubular string.

Statement 20: The method of any preceding statement, wherein the information handling system is operable to perform an inversion to determine parameters of an inner-most pipe which comprises measuring a response in a shallow mode on the corrosion detection tool, performing a numerical inversion with data from a library and a forward model, and producing the parameters of the inner-most pipe.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for calibrating a corrosion detection tool comprising:
disposing the corrosion detection tool in a calibration area;
powering a transmitter and measuring a response on a receiver on the corrosion detection tool;
disposing the corrosion detection tool in a test pipe;
powering the transmitter and measuring the response on the receiver on the corrosion detection tool while disposed within the test pipe; and
determining a multiplicative factor for the receiver.

2. The method of claim 1, further comprising determining an offset for a bucked coil on the corrosion detection tool.

3. The method of claim 2, further comprising altering a structure of the bucked coil or a number of turns of the bucked coil to place the bucked coil within tolerances.

4. The method of claim 1, further comprising applying coefficients to measurements for the receiver to correct for non-linear measured responses, wherein the coefficients are obtained from a library of responses.

5. The method of claim 4, wherein the library of responses is constructed from data on different configurations of a tubular string.

6. The method of claim 5, further comprising performing an inversion to estimate properties of the test pipe.

7. The method of claim 6, wherein the inversion is verified within an allowable tolerance.

8. The method of claim 1, further comprising performing a temperature correction which comprises: acquiring raw data, applying filtering and averaging to the raw data, applying calibration and temperature correction to the raw data, and performing an inversion on the raw data to obtain a thickness of a tubular string.

9. A system comprising:
a corrosion detection tool, wherein the corrosion detection tool comprises:
a transmitter;
a receiver; and
a bucked coil;
a test pipe; and
an information handling system, wherein the information handling system is operable to perform determine a multiplicative factor for the receiver based on a first response measured for the receiver in a calibration area and a second response measured for the receiver in a test pipe.

10. The system of claim 9, wherein the bucked coil may comprise one or more sub-windings wound in opposite directions, wherein a first winding is wound in a first direction and a second winding is wound in a second direction.

11. The system of claim 9, wherein the information handling system is operable to apply a coefficient to correct for non-linear measured responses, wherein the coefficient is obtained from a library of coefficients.

12. The system of claim 9, wherein the information handling system is operable to perform an inversion to estimate properties of the test pipe.

13. The system of claim 9, wherein the information handling system is operable to power the transmitter and measure a response on the receiver on the corrosion detection tool.

14. The system of claim 9, wherein the information handling system is operable to power the transmitter and measure a response on the receiver on the corrosion detection tool where the corrosion detection tool is disposed in the test pipe.

15. The system of claim 9, further comprising a plurality of receivers on the corrosion detection tool.

16. A method for operating a corrosion detection tool comprising:
disposing the corrosion detection tool in a tubular string;
powering the transmitter;
measuring a response on a receiver on the corrosion detection tool while disposed within the tubular string;
storing the response as a raw data from the receiver on an information handling system; and
calculating properties of the tubular string from the raw data.

17. The method of claim 16, further comprising a step to determine parameters of an inner-most pipe which comprises measuring a response in a shallow mode on the corrosion detection tool, performing a numerical inversion with data from a library and a forward model, and producing the parameters of the inner-most pipe.

18. The method of claim 16, further comprising a step to determine parameters of an outer-most pipe which comprises measuring a response in a deep mode on the corrosion detection tool, performing a numerical inversion with data from a library and a forward model from the parameters of an outer-most pipes, and producing the parameters of the outer-most pipe.

19. The method of claim 16, wherein the information handling system is operable to perform a temperature correction which comprises, applying filtering and averaging to the raw data, applying calibration and temperature correction to the raw data, and performing an inversion on the raw data to obtain a thickness of the tubular string.

20. The method of claim 16, wherein the information handling system is operable to perform an inversion to determine parameters of an inner-most pipe which comprises measuring a response in a shallow mode on the corrosion detection tool, performing a numerical inversion with data from a library and a forward model, and producing the parameters of the inner-most pipe.
